(19) United States
(12) Patent Application Publication
(10) Pub. No.: US 2021/0131781 A1
(43) Pub. Date: May 6, 2021

(54) Audio Capture Measuring Tape

(71) Applicant: Apex Brands, Inc., Apex, NC (US)

(72) Inventors: Tobias McKay Bridges, Nolensville, TN (US); Kay Randolph Ligon, Raleigh, NC (US); Kevin Fitzpatrick, Apex, NC (US); Vlad Petru Patrangenaru, Ellicott City, MD (US); Ian Cunningham, Charlotte, NC (US)

(21) Appl. No.: 16/639,440

(22) PCT Filed: Aug. 16, 2018
(86) PCT No.: PCT/IB2018/056165

§ 371 Date: Feb. 14, 2020

Related U.S. Application Data
(60) Provisional application No. 62/546,467, filed on Aug. 16, 2017.

(51) Int. Cl. G01B 3/1061; G01B 3/1094; G01B 3/1056; G01B 3/00; G01B 3/1041; G10L 15/22

(52) U.S. Cl. CPC G01B 3/1061; G01B 3/1094; G10L 15/22; G01B 3/006; G01B 3/1041; G01B 3/1056

(57) ABSTRACT

An example distance measuring apparatus is provided. The example apparatus may include a housing having an aperture, a reel assembly, a measuring tape, a touch control, an audio output device, an audio input device, and processing circuitry. The processing circuitry may be configured to receive a touch control signal and initiate a measurement acquisition session, receive verbal measurement audio data from the audio input device, perform a speech recognition analysis on the verbal measurement audio data to determine measurement data, and store the measurement data in a memory device.

### CROSS REFERENCE TO RELATED APPLICATIONS

This application claims the benefit of U.S. provisional application No. 62/546,467 filed on Aug. 16, 2017, the entire contents of which are hereby incorporated by reference.

### TECHNICAL FIELD

Example embodiments generally relate to measuring tape devices, and particularly relate to automated measuring tape technologies.

### BACKGROUND

Measuring tapes are common tools used in numerous contexts to obtain linear measurements. While ergonomic and other physical improvements to measuring tapes have been achieved over the years, the same workflow with respect to measuring tapes continues to be used. In short, that workflow is to measure with the tape, mark a measurement, and record the measurement on a notepad or drawing. It is clear that improvements in this area of technology would be beneficial.

### BRIEF SUMMARY OF SOME EXAMPLES

An example distance measuring apparatus is provided. The example apparatus may comprise a housing having an aperture, a reel assembly, and a measuring tape having a first end configured to extend from the housing through the aperture and a second end configured to be wound on the reel assembly. The measuring tape may have distance measurement indicia. The example apparatus may further comprise a touch control. The touch control may be configured send a touch control signal. The example apparatus may further comprise an audio output device, an audio input device, and processing circuitry. The processing circuitry may be configured to receive the touch control signal and initiate a measurement acquisition session in response to the touch control signal, and receive verbal measurement audio data from the audio input device. The verbal measurement audio data may comprise audio of a verbally communicated measurement. The processing circuitry may be further configured to perform a speech recognition analysis on the verbal measurement audio data to determine measurement data and store the measurement data in a memory device.

Another example apparatus comprises a communications interface comprising an antenna, and processing circuitry comprising a processor and a memory. The processing circuitry may be configured to receive a touch control signal, via the antenna, from a touch control of a measuring tape and initiate a measurement acquisition session in response to the touch control signal and receive verbal measurement audio data from an audio input device. The verbal measurement audio data may comprise audio of a verbally communicated measurement. The processing circuitry may be further configured to perform a speech recognition analysis on the verbal measurement audio data to determine measurement data and store the measurement data in the memory.

An example method may comprise receiving a touch control signal, via an antenna, from a touch control of a measuring tape and initiating a measurement acquisition session in response to the touch control signal and receiving verbal measurement audio data from an audio input device. The verbal measurement audio data may comprise audio of a verbally communicated measurement. The example method may further comprise performing a speech recognition analysis, using processing circuitry, on the verbal measurement audio data to determine measurement data and storing the measurement data in a memory.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a distance measuring apparatus in accordance with an example embodiment;

FIG. 2 illustrates a distance measuring apparatus partially embodied in peripheral devices in accordance with an example embodiment;

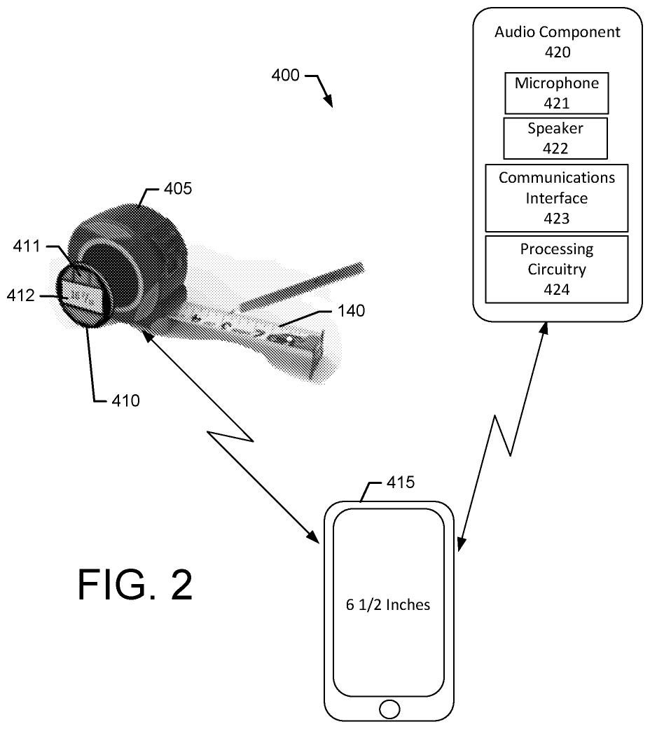

FIG. 3 illustrates an example flow chart for a measurement acquisition session in accordance with an example embodiment;

FIG. 4 illustrates an example scenario for implementing a measurement acquisition session in accordance with an example embodiment;

FIG. 5 illustrates an example distance measuring apparatus in accordance with an example embodiment; and

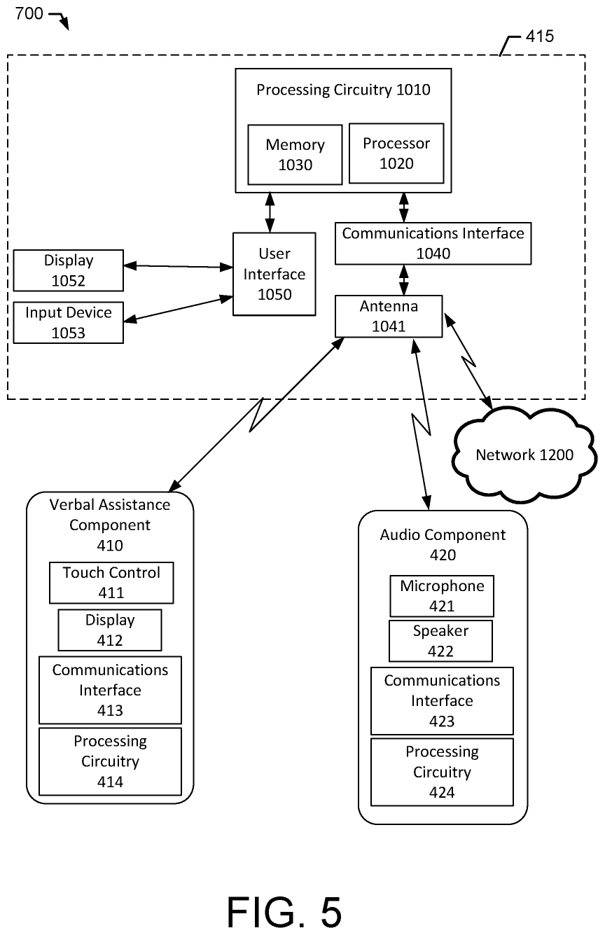

FIG. 6 illustrates an example method in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a measuring tape device that may have improved measurement workflow capabilities. This may be accomplished by recording verbal recitations of measurements for storage and reuse in later applications, such as, to auto-populate measurements on a drawing, or to share measurements with other individuals on a large project. The capability to record verbal recitations of measurements changes the conventional measurement workflow in such a way that no longer requires writing down measurements on, for example, a pad.

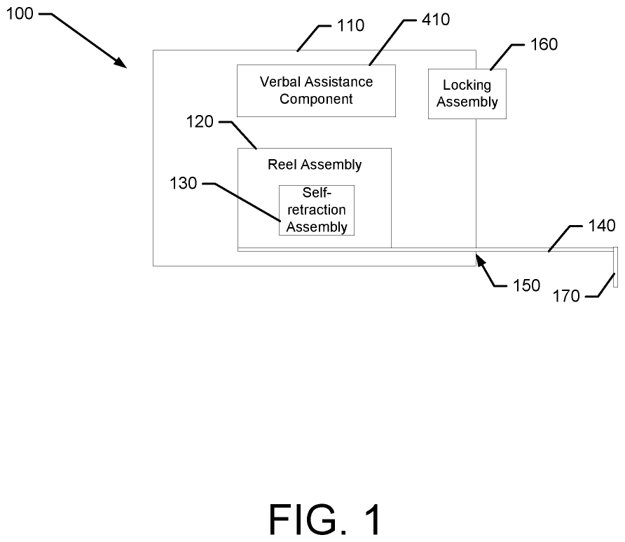

FIG. 1 illustrates a block diagram of such device, in accordance with an example embodiment. A distance measuring apparatus 100 of an example embodiment may include a housing 110 inside which a reel assembly 120 and a self-retraction assembly 130 may be provided. A tape 140 of the device 100 may be wound onto the reel assembly 120. The tape 140 may be paid out through or retracted into an aperture 150 formed in the housing 110. Although not required, in some cases, a locking assembly 160 may be provided to enable the reel assembly 120 to be locked to prevent the self-retraction assembly 130 from retracting the tape 140 when the locking assembly 160 is engaged. The locking assembly 160 may include a button or switch that moves to lock the tape 140 in position or unlock the tape 140 and permit the tape 140 to retract into the housing 110 or extend further.

The tape 140 may have an end hook 170 disposed at one end thereof, and may be affixed to the reel assembly 120 at the other end of the tape 140. The end hook 170 may be affixed (temporarily) to an anchor point on a medium that is to be measured. With the end hook 170 affixed to the anchor point, the tape 140 may be paid out of the aperture 150 and unwound or rolled out from the reel assembly 120. When a desired length of the tape 140 has been rolled out, the user can make any necessary markings, readings, etc., associated with distance measurement indicia that may be printed on the tape 140. The distance measurement indicia generally measure length from the end hook 170 in one or more units, with divisions and subdivisions of such units clearly marked on the edge tape 140 with numbering to show integer units of measure. The distance measurement indicia may include measurement numbers and tick marks indicating units or sub-units of measurement.

By fixing the end hook 170 to the anchor point, the self-retraction assembly 130 (which may be spring loaded in some cases) may be prevented from retracting the paid out portion of the tape 140 into the housing 110 (via the aperture 150). Similarly, when the locking assembly 160 is in a locked position, a force (e.g., a pinching force) may be placed on the tape 140 to prevent retraction or motion of the reel assembly 120. As such, the locking assembly 160 may prevent the self-retraction assembly 130 from retracting the paid out portions of the tape 140. However, when the end hook 170 is not anchored and the locking assembly 160 is unlocked, the self-retraction assembly 130 may cause the reel assembly 120 to wind the tape 140 back onto the reel assembly 120.

According to some example embodiments, when the tape 140 is paid out through the aperture 150, the tape 140 will extend relatively straight out the aperture 150 (although some sagging or drooping may be noticed due to the weight of the tape 140). The tape 140 can be extended in a guided fashion toward an intended target anchor point while the tape 140 continues to have sufficient rigidity to standout.

Additionally, the distance measuring apparatus 100 may include a verbal assistance component 410. According to some example embodiments, the verbal assistance component 410 may be configured to assist a user with recording verbal recitations of a measurement as the measurement is being made. This avoids the need to write down measurement values while taking the steps to make measurements. The verbal assistance component 410 may include a touch control or button that may trigger, for example, the distance measuring apparatus 100 or a mobile terminal to initiate a measurement acquisition session to record and store a measurement. According to some example embodiments, the distance measuring apparatus 100 may be configured to perform functionalities needed to record and store measurements.

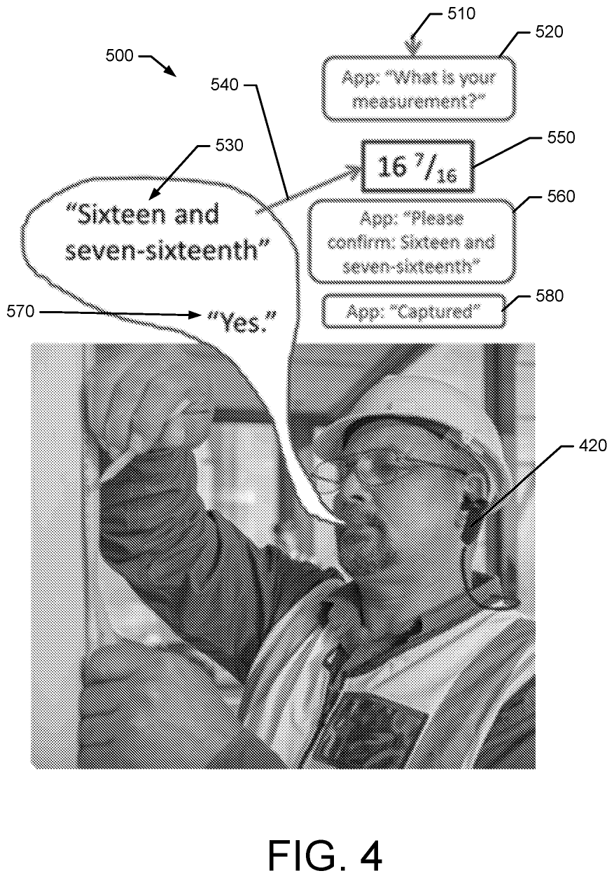

Another example embodiment of a distance measuring apparatus 400 is shown in FIG. 4. In this regard, rather than the components and functionalities being housed in a single device as described with respect to distance measuring apparatus 100, the distance measuring apparatus 400 may employ a distributed approach to form an example distance measuring apparatus.

In this regard, the distance measuring apparatus 400 may comprise a tape measure 405 having a verbal assistance component 410, a mobile terminal 415, and an audio component 420 having a microphone 421 and a speaker 422. The tape measure 405, the verbal assistance component 410, the mobile terminal 415, and the audio component 420 may operate together to assist a user with recording measurements. The tape measure 405 may mechanically operate similar to the distance measuring apparatus 100 described above with respect to FIG. 1. The verbal assistance component 410 may be an electronic device that includes a processor, a display 412, a touch control 411, and a wireless communications interface including an antenna. According to some example embodiments, the verbal assistance component 410 may be attachable and removable from the tape measure 405. In this regard, the verbal assistance component 410 may be part of an add-on or upgrade kit to a purely mechanical tape measure 405.

The mobile terminal 415 may be any type of smart phone, tablet, or other type of handheld wireless communications device that is configured to run, for example, an application (or “app”) that configures the mobile terminal 415 to assist with recording verbal measurements. The mobile terminal 415 may be a core component of the distance measuring apparatus 400 as further described below with the tape measure 405 (and the verbal assistance component 410) and the audio component 420 operating as peripheral devices. The mobile terminal 415 may include processing circuitry configured to, for example, receive and analyze a recorded audible measurement. In this regard, the mobile terminal 415 may include a communications interface capable of linking with the verbal assistance component 410 and the audio component 420 via, for example, Bluetooth.

The audio component 420 may include a microphone 421 and a speaker 422. In this regard, the audio component 420 may include a pair of headphones and a microphone to interface with the mobile terminal 415 as a wireless audio user interface. The audio component 420 may also include processing circuitry 424 which may be largely concerned with implementing a communications interface 424 for linking with the mobile terminal 415. The audio component 420 may include a mounting assembly configured to mount the audio component 420 to a user (e.g., a user's ears) or a user-wearable article.

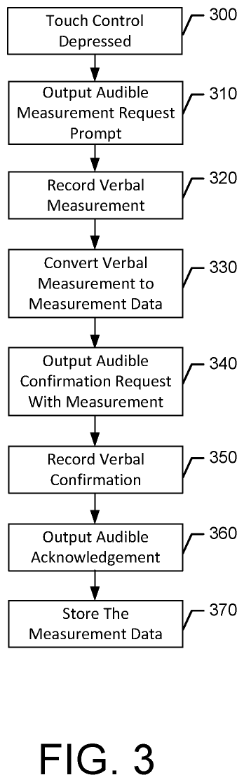

FIG. 3 shows a flow chart for an example verbal measurement acquisition session, according to some example embodiments. In this regard, the verbal measurement acquisition session may be initiated by the touch control 411 of the verbal assistance component 410 being depressed at 300. In this regard, the touch control 411 may be depressed which may generate a touch control signal that is ultimately wirelessly transmitted to the mobile terminal 415. In response to receiving the touch control signal, the mobile terminal 415 may direct the audio component 420 to output an audible measurement request prompt to the user. In this regard, the user may be requested to state the current measurement for recording.

Accordingly, at 320, the mobile terminal 415 may record the verbal measurement by obtaining audio data from the microphone 421, via a wireless communication with the audio component 420. Upon recording the received verbal measurement, the mobile terminal 415 may be configured to convert the verbal measurement into measurement data (e.g., in the form of a value) at 330 of a different digital format that may be useful for data manipulation and storage (relative to an audio file). Based on the measurement data, the mobile terminal 415 may then transmit a signal to the audio component 420 to output an audible confirmation request with the measurement at 340, via the speaker 422. The mobile terminal 415 may subsequently record a verbal confirmation from the microphone 421, via a wireless communication with the audio component 420. Upon recording the verbal confirmation, the mobile terminal 415 may issue an output audible acknowledgment via the speaker 422. Subsequently, at 370, the measurement data may be stored for later use. Additionally, the mobile terminal 415 may be further configured to send the measurement data to the verbal assistance component 410 for display on the display 412.

Turning to FIG. 4, an example verbal measurement acquisition session 500 is provided that is based on the operations of the flow chart of FIG. 3. It is noteworthy that the worker is using a wireless audio device as the audio component 420 that both transmits and receives, and is connected to at least to the mobile terminal 415. In this regard, the session may begin at 510 in response to, for example, depression of a touch control 411 on a tape measure 405 because the worker is prepared to record a measurement. In response, the worker may hear from the speaker 422, “What is your measurement?” at 520, which may have been sent to the speaker 422 from the mobile terminal 415. At 530, the user may respond by stating “sixteen and seven-sixteenths,” which will be received by the microphone 421 and sent to the mobile terminal 415. At 540, the mobile terminal 415 may convert this audio data into a more usable digital format via speech recognition as shown in 550. Subsequently, the mobile terminal 415 may send a message to be output, via the speaker 422, requesting confirmation of the measurement to the user at 560. The message, provided by the app of the mobile terminal 415, may state “Please confirm: Sixteen and seven-sixteenths.” In response, the worker confirms the stated measurement by stating “yes” at 570 in response to the confirmation prompt. Subsequently, the mobile terminal 415 may state that the app has recorded the measurement by stating “Captured.” As such, the measurement may be stored either, for example, on the mobile terminal 415 or in the cloud and possibly sent the verbal assistance component 410 for display. The verbal measurement acquisition session 500 would then be closed to permit a new session to be opened by engaging the touch control 411.

FIG. 7 shows a block diagram of some components of a distance measuring apparatus 700, largely from an electronics perspective, that comprises the verbal assistance component 410, mobile terminal 415, and the audio component 420. With respect to the mobile terminal 415, according to some example embodiments, processing circuitry 1010 that may be in operative communication with or embody, a communications interface 1040 and a user interface 1050. The processing circuitry 1010 may interact with or embody a memory 1030 and a processor 1020. The processing circuitry 1010 is configurable to perform operations described herein. In this regard, the processing circuitry 1010 may be configured to perform computational processing and memory management according to an example embodiment. In some embodiments, the processing circuitry 1010 may be embodied as a chip or chip set. In other words, the processing circuitry 1010 may comprise one or more physical packages (e.g., chips) including materials, components or wires on a structural assembly (e.g., a baseboard). The processing circuitry 1010 may be configured to receive inputs (e.g., via peripheral components including the memory 1030), perform actions based on the inputs, and generate outputs (e.g., for provision to peripheral components). In an example embodiment, the processing circuitry 1010 may include one or more instances of a processor 1020, associated circuitry, and memory 1030. As such, the processing circuitry 1010 may be embodied as a circuit chip (e.g., an integrated circuit chip, such as a field programmable gate array (FPGA)) configured (e.g., with hardware, software or a combination of hardware and software) to perform operations described herein.

In an example embodiment, the memory 1030 may include one or more non-transitory memory devices such as, for example, volatile or non-volatile memory that may be either fixed or removable. The memory 1030 may be volatile or non-volatile and configured to store information, data, applications, instructions or the like for enabling, for example, object recognition and presentation and to carry out various functions in accordance with exemplary embodiments. For example, the memory 1030 could be configured to buffer input data for processing by the processing circuitry 1010. Additionally or alternatively, the memory 1030 could be configured to store instructions for execution by the processing circuitry 1010. Among the contents of the memory 1030, applications may be stored for execution by the processing circuitry 1010 in order to carry out the functionality associated with each respective application.

As mentioned above, the processing circuitry 1010 may be embodied in a number of different ways. For example, the processing circuitry 1010 may be embodied as various processing means such as one or more processors 1020 that may be in the form of a microprocessor or other processing element, a coprocessor, a controller or various other computing or processing devices including integrated circuits such as, for example, an ASIC (application specific integrated circuit), an FPGA, or the like. In an example embodiment, the processing circuitry 1010 may be configured to execute instructions stored in the memory 1030 or otherwise accessible to the processing circuitry 1010. As such, whether configured by hardware or by a combination of hardware and software, the processing circuitry 1010 may represent an entity (e.g., physically embodied in circuitry—in the form of processing circuitry 1010) capable of performing operations according to example embodiments while configured accordingly. Thus, for example, when the processing circuitry 1010 is embodied as an ASIC, FPGA, or the like, the processing circuitry 1010 may be specifically configured hardware for conducting the operations described herein. Alternatively, as another example, when the processing circuitry 1010 is embodied as an executor of software instructions, the instructions may specifically configure the processing circuitry 1010 to perform the operations described herein.

The communication interface 1040 may include one or more interface mechanisms for enabling communication with other devices external to mobile terminal 415, via, for example, a network, such as a local area network. In some cases, the communication interface 1040 may be any means such as a device or circuitry embodied in either hardware, or a combination of hardware and software that is configured to receive or transmit data from/to devices in communication with the processing circuitry 1010. The communications interface 1040 may be a wired or wireless interface and may support various communications protocols. Communications interface 1040 may be operably coupled to an antenna 1041 to support wireless communications to other components. In this regard, the communications interface 1040 and the antenna 1041 may support communications via, for example, Bluetooth or WIFI connections.

As described above, the verbal assistance component 410 may include the touch control 411, a display 412, a communications interface 413, and processing circuitry 414. The verbal assistance component 410 may be affixed to or disposed within a housing that is shared with the measuring tape 140. The verbal assistance component 410 may be removable from this shared housing. The processing circuitry 414 may be physically similar to the processing circuitry 1010, although configured differently to support the operations of the distance measuring apparatus 700. The processing circuitry 414 may be configured to control and monitor the operations of the verbal assistance component 410 generally, the touch control 411, the display 412, and the communications interface 413. The communications interface 413 may operate similar to the communications interface 1040 and may include an antenna. The touch control 411 may be configured to, for example, receive a touch or press and, in response, initiate the sending of an request to open a measurement acquisition session to the processing circuitry 1010.

As described above, the audio component 420 may include an audio input device, such the a microphone 421 and an audio output device such as a speaker 422. The audio component 420 may further comprise, a communications interface 423, and processing circuitry 424. According to some example embodiments, the audio component 420 may be peripheral device, such as a pair of wireless ear buds with a microphone or the like. According to some example embodiments, rather than being a separate component, the microphone 421 and the speaker 422 may be integrated into the mobile terminal 415 such that a user simply interfaces directly with the mobile terminal 415, rather than through the peripheral device that is the audio component 420. The processing circuitry 424 may be physically similar to the processing circuitry 1010, although configured differently to support the operations of the distance measuring apparatus 700. The processing circuitry 424 may be configured to control and monitor the operations of the audio component 420 generally and the microphone 421, the speaker 422, and the communications interface 423. The communications interface 423 may operate similar to the communications interface 1040 and may include an antenna.

The user interface 1050, associated with the processing circuitry 1010, may be controlled by the processing circuitry 1010 to interact with a user. In this regard, the processing circuitry 1010 may be configured to receive inputs from a user via the input device 1053. The user interface 1050 may also output information to a user by, for example, driving a display 1052. According to some example embodiments, the user interface 1050 may also operably couple to other user input devices such as, for example, a keyboard, mouse, touch screen, or the like. Further, the user interface 1050 may also operably couple with the communications interface 1040 to receive inputs and provide outputs to remote devices that are connected via, for example, a wireless connection.

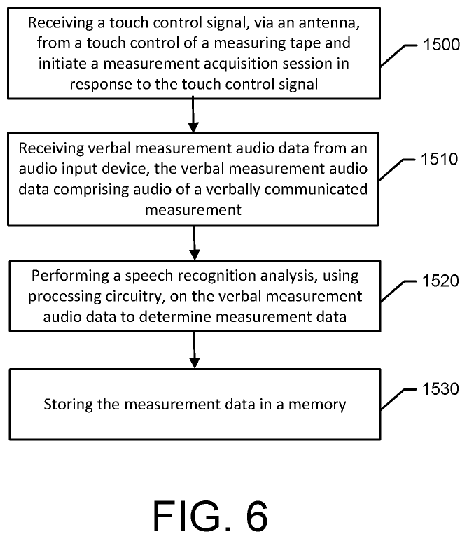

In an example embodiment, the processing circuitry 1010 may be embodied as, include or otherwise control, the apparatus 700 to perform measurement verbal assistance as described herein. As such, in some embodiments, the processing circuitry 1010 may be said to cause each of the operations described in connection with, for example, the distance measuring apparatus 100, and 400, the operations of the flow chart of FIG. 3, the scenario of FIG. 4, the method of FIG. 6, and the functionalities otherwise described herein. The processing circuitry 1010 may therefore undertake the corresponding functionalities responsive to execution of instructions or algorithms configuring the processing circuitry 1010 accordingly. The processing circuitry 1010 may provide programmable control signals, selections, and the like to control the operation of the apparatus 700 responsive to execution of instructions stored in the memory 1030.

According to some example embodiments, the processing circuitry 1010 may be configured to receive a touch control signal from touch control 411 and initiate a measurement acquisition session in response to the touch control signal. The processing circuitry 1010 may also be configured to receive verbal measurement audio data from the audio input device such as the microphone 421. In this regard, the verbal measurement audio data may comprise audio of a verbally communicated measurement. The processing circuitry 1010 may be further configured to perform a speech recognition analysis on the verbal measurement audio data to determine measurement data, and store the measurement data in a memory device such as memory 1030.

According to some example embodiments, the processing circuitry 1010 may be further configured to receive verbal measurement description audio data from the audio input device (e.g., microphone 421) and store a version of the verbal measurement description audio data in association with the measurement data. The verbal measurement description may uniquely identify the measurement data within a project that may involve a number of measurements. According to some example embodiments, the processing circuitry 1010 may be configured to store the measurement data on a server via a network communication, wherein the measurement data is stored in association with other measurement data for a common project. In this regard, other measurement data is not provided to the server by the apparatus 700. The processing circuitry 1010, according to some example embodiments, may be further configured to transmit a user prompt requesting the verbally communicated measurement to the audio output device (e.g., speaker 422). According to some example embodiments, the processing circuitry 1010 is further configured to transmit an audio version of the measurement data to the audio output device (e.g., speaker 422) for output to the user.

According to some example embodiments, the functionalities described herein with respect to the mobile terminal 415 may be alternatively performed by a properly equipped verbal assistance component 410 of a tape measure (e.g., tape measure 100 or 405). In this regard, the functionalities described with respect to processing circuitry 1010 may alternatively be performed by the processing circuitry 414 and the audio component 420 may connect to the communications interface 413 to support communications directly between the audio component 420 and the verbal assistance component 410. Further, according to some example embodiments, the microphone 421 and the speaker 422 may be integrated into the verbal assistance component 410 such that the functionalities described herein can be implemented at the tape measure 100 or 405.

FIG. 6 shows an example method according to various example embodiments. In this regard, the example method of FIG. 6 may be performed by, for example, the apparatus 700 described above. The example method may include the following in addition to or alternative to any of the functionalities or operations described herein. The example method may comprise, at 1500, receiving a touch control signal, via an antenna, from a touch control of a measuring tape and initiating a measurement acquisition session in response to the touch control signal. At 1510, the example method may comprise receiving verbal measurement audio data from an audio input device. The verbal measurement audio data may comprise audio of a verbally communicated measurement. The example method may further comprise at 1520 performing a speech recognition analysis, using processing circuitry, on the verbal measurement audio data to determine measurement data, and, at 1530, storing the measurement data in a memory.

According to some example embodiments, the example method may further comprise receiving verbal measurement description audio data from the audio input device and storing a version of the verbal measurement description audio data in association with the measurement data. According to some example embodiments, the example method may further comprise storing the measurement data on a server via a network communication. In this regard, the measurement data may be stored in association with other measurement data for a common project.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A distance measuring apparatus comprising:
a housing having an aperture;
a reel assembly;
a measuring tape having a first end configured to extend from the housing through the aperture and a second end configured to be wound on the reel assembly, the measuring tape having distance measurement indicia;
a touch control, the touch control being configured send a touch control signal;
an audio output device;
an audio input device; and
processing circuitry configured to:
receive the touch control signal and initiate a measurement acquisition session in response to the touch control signal;
receive verbal measurement audio data from the audio input device, the verbal measurement audio data comprising audio of a verbally communicated measurement;
perform a speech recognition analysis on the verbal measurement audio data to determine measurement data; and
store the measurement data in a memory device.

2. The distance measuring apparatus of claim 1, wherein the touch control, the audio output device, and the audio input device communicate with the processing circuitry via a wireless connection.

3. The distance measuring apparatus of claim 1, wherein the processing circuitry is housed in a mobile terminal.

4. The distance measuring apparatus of claim 1, wherein the processing circuitry is further configured to receive verbal measurement description audio data from the audio input device and store a version of the verbal measurement description audio data in association with the measurement data.

5. The distance measuring apparatus of claim 1, wherein the processing circuitry is configured to store the measurement data on a server via a network communication, wherein the measurement data is stored in association with other measurement data for a common project.

6. The distance measuring apparatus of claim 2, wherein the other measurement data is not provided by the distance measuring apparatus.

7. The distance measuring apparatus of claim 1, wherein the processing circuitry is further configured to transmit a user prompt requesting the verbally communicated measurement to the audio output device.

8. The distance measuring apparatus of claim 7, wherein the processing circuitry is further configured to transmit an audio version of the measurement data to the audio output device for output to the user.

9. An apparatus comprising:
a communications interface comprising an antenna; and
processing circuitry comprising a processor and a memory, the processing circuitry configured to:
receive a touch control signal, via the antenna, from a touch control of a measuring tape and initiate a measurement acquisition session in response to the touch control signal;
receive verbal measurement audio data from an audio input device, the verbal measurement audio data comprising audio of a verbally communicated measurement;
perform a speech recognition analysis on the verbal measurement audio data to determine measurement data; and
store the measurement data in the memory.

10. The apparatus of claim 9, wherein the touch control, the audio output device, and the audio input device communicate with the processing circuitry via a wireless connection.

11. The apparatus of claim 9, wherein the processing circuitry is housed in a mobile terminal.

12. The apparatus of claim 9, wherein the processing circuitry is further configured to receive verbal measurement description audio data from an audio input device and store a version of the verbal measurement description audio data in association with the measurement data.

13. The apparatus of claim 9, wherein the processing circuitry is further configured to store the measurement data on a server via a network communication, wherein the measurement data is stored in association with other measurement data for a common project.

14. The apparatus of claim 9, wherein the processing circuitry is further configured to transmit a user prompt requesting the verbally communicated measurement to the audio output device.

15. The apparatus of claim 14, wherein the processing circuitry is further configured to transmit an audio version of the measurement data to the audio output device for output to the user.

16. A method comprising:
receiving a touch control signal, via an antenna, from a touch control of a measuring tape and initiate a measurement acquisition session in response to the touch control signal;
receiving verbal measurement audio data from an audio input device, the verbal measurement audio data comprising audio of a verbally communicated measurement;
performing a speech recognition analysis, using processing circuitry, on the verbal measurement audio data to determine measurement data; and
storing the measurement data in a memory.

17. The method of claim 16, wherein the touch control, the audio output device and the audio input device communicate with the processing circuitry via a wireless connection.

18. The method of claim 16, wherein the processing circuitry is housed in a mobile terminal.

19. The method of claim 16, further comprising receiving verbal measurement description audio data from the audio input device and storing a version of the verbal measurement description audio data in association with the measurement data.

20. The method of claim 16, further comprising storing the measurement data on a server via a network communication, wherein the measurement data is stored in association with other measurement data for a common project.
